(19) United States
(12) Patent Application Publication
(10) Pub. No.: US 2003/0204944 A1
(43) Pub. Date: Nov. 6, 2003

(54) Forming gas turbine transition duct bodies without longitudinal welds

(76) Inventor: Richard S. Norek, Eliot, ME (US)

Correspondence Address: DECKER LAW OFFICE, 1 NEW HAMPSHIRE AVE., SUITE 125, PORTSMOUTH, NH, 03801, US

(21) Appl. No.: 10/139,494

(22) Filed: May 6, 2002

(51) Int. Cl. B23P 17/00

(52) U.S. Cl. 29/421.1

(57) ABSTRACT

A method of making combustion turbine transition duct bodies without longitudinal welds by hydroforming at least one in a hydroforming press. Ideally, two transition duct bodies can be made simultaneously with their exit ducts joined together, which can be cut after hydroforming. Apparatus for hydroforming transition ducts includes axial compression members and pressure intensifiers to impart highly detailed features into the work piece.

### BACKGROUND

1. Field of the Invention

This invention relates to transition duct bodies used in gas turbines.

2. Description of the Related Art

Associated with gas turbines with multiple cannular combustors are transition ducts that carry hot gases from the combustors to the turbine inlet as shown schematically in FIG. 1. The combustors 12 are round, but the turbine inlet is annular. Therefore, the transition duct bodies 10 must have round inlets 16 and an exit 18 that forms a segment of an annulus.

The highly curved walls of the duct body 10 are difficult to fabricate. The difficulty is compounded by an offset 14 between the duct inlet 16 and duct exit 18. The offset 14 is the distance between the centerline of the combustor 12 and the centerline of the duct exit 18.

According to the current art, large transition pieces are fabricated by welding together a number of individual components. The largest component is the main body of the duct 10 shown in FIG. 2. It is typically made of two curved shells 20 and 22 that are stamped separately, trimmed to size, and then welded together. The welds 11 are shown in FIG. 1.

To facilitate removal from the dies after stamping of the two separate parts, the joints between these parts must pass through the widest contour lines on the sides of the duct body 10. Consequently, the longitudinal welds 11 terminate in the highly stressed upper corners of the duct exit 18 and have the effect of weakening these corners. This makes the longitudinal welds undesirable.

In addition, some duct bodies 10 require circumferential welds. Circumferential welds would be needed, for instance, to attach a frame for exit seals or support brackets, not shown in the drawing. They would cross the longitudinal welds in the duct bodies 10, thus producing more weak spots. Inherently, welding causes weld distortion. To achieve the required dimensional tolerances, special fixtures are typically required for welding, stress relieving, and heat treatment.

The conventional method of fabrication is difficult, time consuming, and very costly. Some large transition duct bodies cost more than a full-size automobile, each. In any case, a set of four to fourteen transition ducts per gas turbine required by a great majority of operating combustion turbine units represents a prime target for cost reduction.

What is needed, therefore, is a less costly method and apparatus for making stronger transition duct bodies that does not require longitudinal welding.

### SUMMARY

An invention that satisfies the need for a less costly method and apparatus for making stronger transition duct bodies that does not require longitudinal welding comprises hydroforming one or more transition duct bodies between two dies in a hydroforming press from seamless pipe. These and other features, aspects, and advantages of the present invention will become better understood with regard to the following description, claims, and accompanying drawings.

### DRAWINGS

FIG. 1 is a perspective view of a transition duct body assembly of the prior art.

FIG. 2 is a perspective view of two components of a transition duct body assembly before welding according to the prior art.

FIG. 3 is a side elevation of hydroforming dies for hydroforming two transition duct bodies without welds simultaneously according to the present invention.

FIG. 4 is a front elevation of the hydroforming dies of FIG. 3.

FIG. 5 is a side elevation of an apparatus for hydroforming two transition duct bodies simultaneously according to the present invention.

FIG. 6 is a side elevation of an apparatus for hydroforming two transition duct bodies simultaneously according to the present invention, showing the axial cylinders and the work piece before forming.

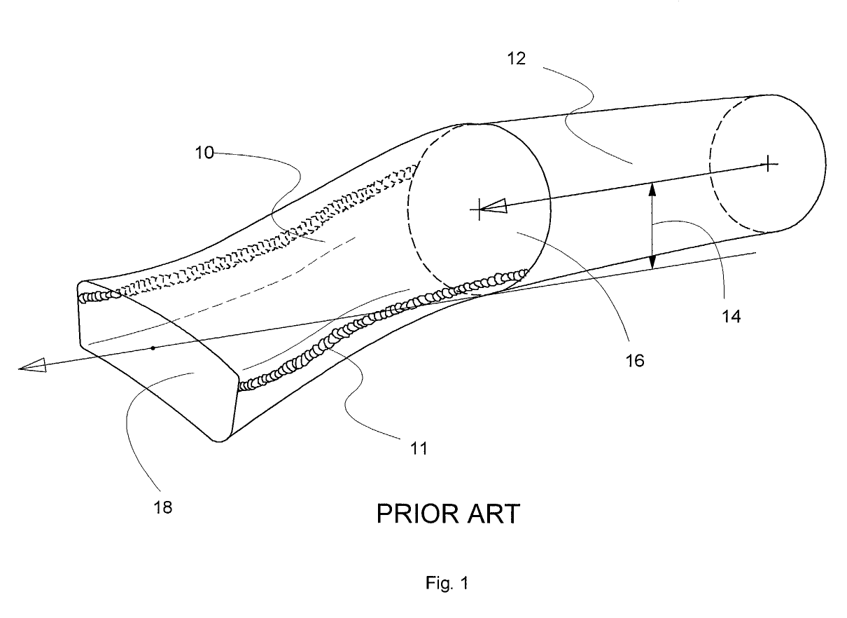

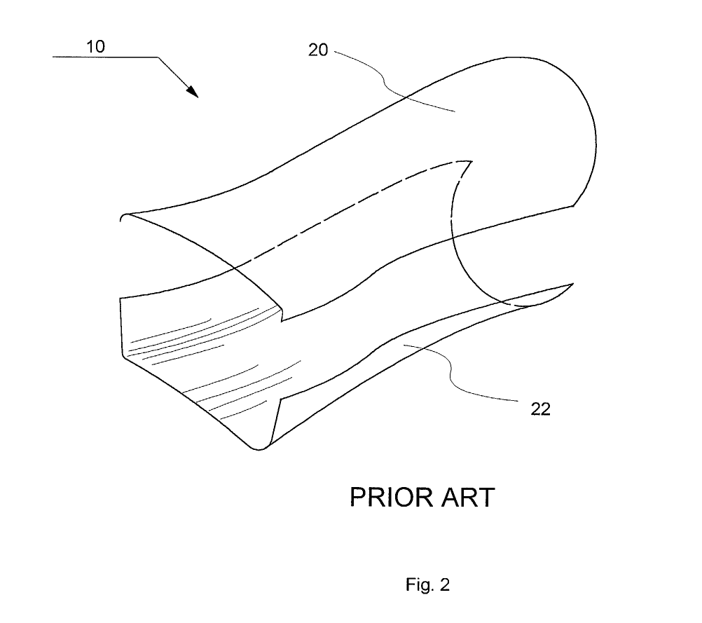

### DESCRIPTION

The purpose of the invention is to produce stronger, better, and less costly transition ducts by improving transition duct bodies. The novel method and apparatus of the present invention comprises hydroforming at least one transition duct body from a pipe by pressurizing the pipe between two dies in a hydroforming press. A seamless pipe is necessary to produce transition duct bodies with no longitudinal welds.

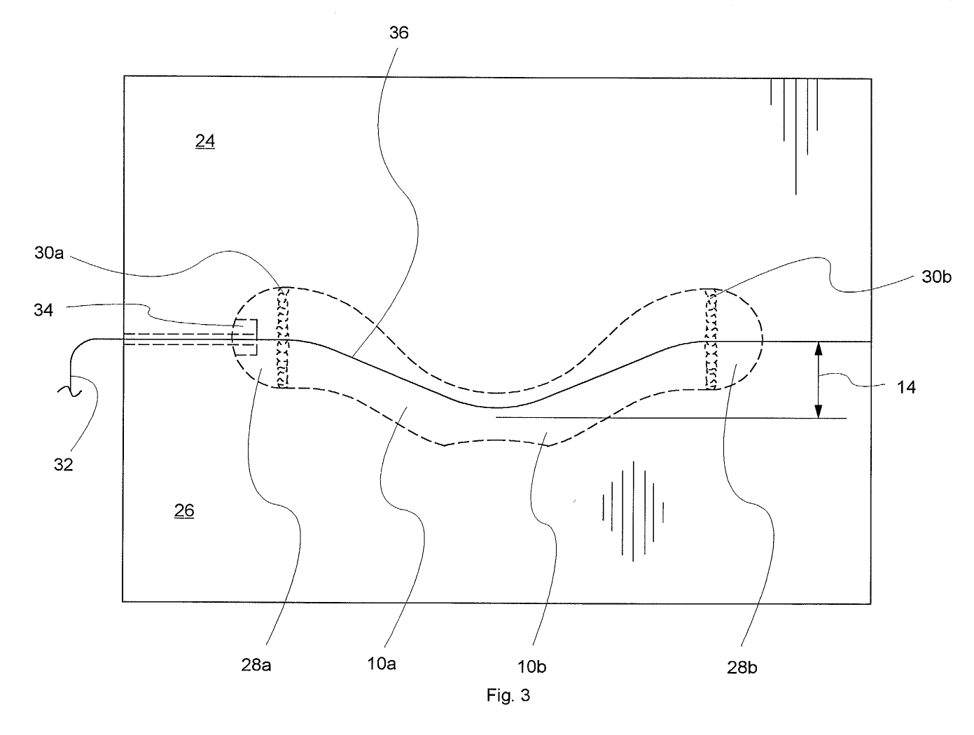

In order to avoid complicated sealing of the annular segment at the transition duct body exit 18, two duct bodies can be formed together, back to back, or exit to exit, as is shown in FIG. 3. After hydroforming, the joined exits of the duct bodies can be separated by laser cutting or other means to obtain two transition duct bodies 10a and 10b.

To pressurize the pipe, both ends must be sealed and provision made for injecting water under high pressure to the pipe interior, precise control of the water pressure during the hydroforming process, and the discharge of water after hydroforming. The required maximum hydroforming pressure depends on the duct overall size, wall thickness, wall material, the smallest radius in the dies, and the capacity of the press holding the dies. The existing large hydroforming presses capacity of 13,600 kg (15,000 tons), and the hydroforming pressure capacity of 1030 bar (15,000 psi) are likely to satisfy any existing transition duct body 10 hydroforming requirements. Refer to the Erie Press System, 1253 West 12th Street, Erie, Pa. 10512.

Each company that performs hydroforming or makes hydroforming equipment has its own method of sealing cylindrical pipe ends. FIG. 3 shows semi-spherical end caps 28a and 28b welded 30a and 30b to the pipe 10a and 10b to assure positive sealing of the pipe interior in case of a slight rotation of the pipe ends during the initial stages of hydroforming. Other methods of sealing the cylindrical pipe ends are presently known in the art, and are considered to be equivalent to this method.

Such rotation takes place due to bending of the pipe to produce an offset 14 between the duct inlet and the exit. The greater the offset 14, the more bending occurs, the more the caps 28a and 28b rotate, and the more the ends move inward.

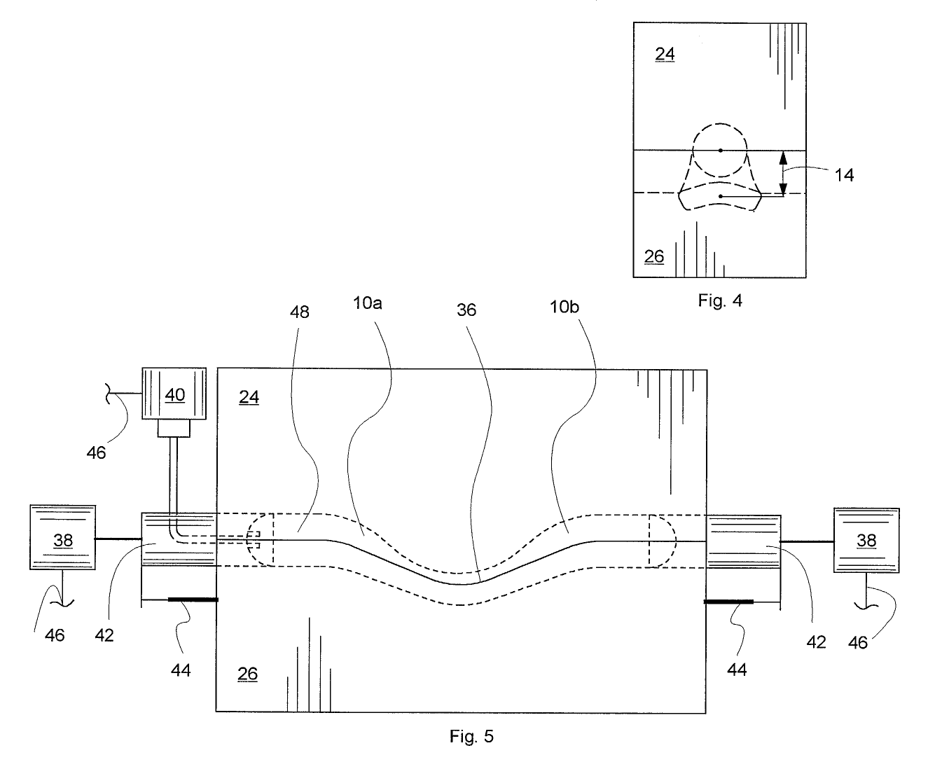

In the arrangement shown in FIGS. 3 and 4, an inner fluid nozzle assembly 34 for introducing a fluid source 32 must be fastened to one of the end caps 28 before the cap is fastened to the tubular pipe. Fastening in the preferred embodiment is done by welds 30a and 30b. The nozzle 34 is for admitting a working fluid 32 for the hydroforming, like water, oil, air, or other suitable fluid.

FIGS. 3 and 4 clearly show the result of two duct bodies 10a and 10b being formed together, with their exit ends facing each other and joined. They are shown as dashed lines because they are inside the hydroforming apparatus. The apparatus comprises an upper die 24 and a lower die 26.

FIG. 5 shows more of the details than FIG. 3 of a hydroforming apparatus for transition duct bodies 10 with a large offset 14. Referring to FIG. 3 and FIG. 5 at the same time, the large offset 14 requires deep bending of the middle of the pipe that emanates an upward rotation of the end caps 28a and 28b, and a movement of the end caps inward. To accommodate this movement, axial compression cylinders 42 shown in FIG. 5 are applied at the pipe ends with compression mechanism 38, preferably hydraulically actuated. The axial force in the cylinders cannot be controlled manually. It must be controlled with an automatic or computerized controller, not shown. This also requires an inner pressure controller that receives position information from a linear transducer 44 connected between the compression cylinder 42 and one of the dies 24 or 26. The inner pressure in the work piece 50 must be carefully controlled for four main reasons.

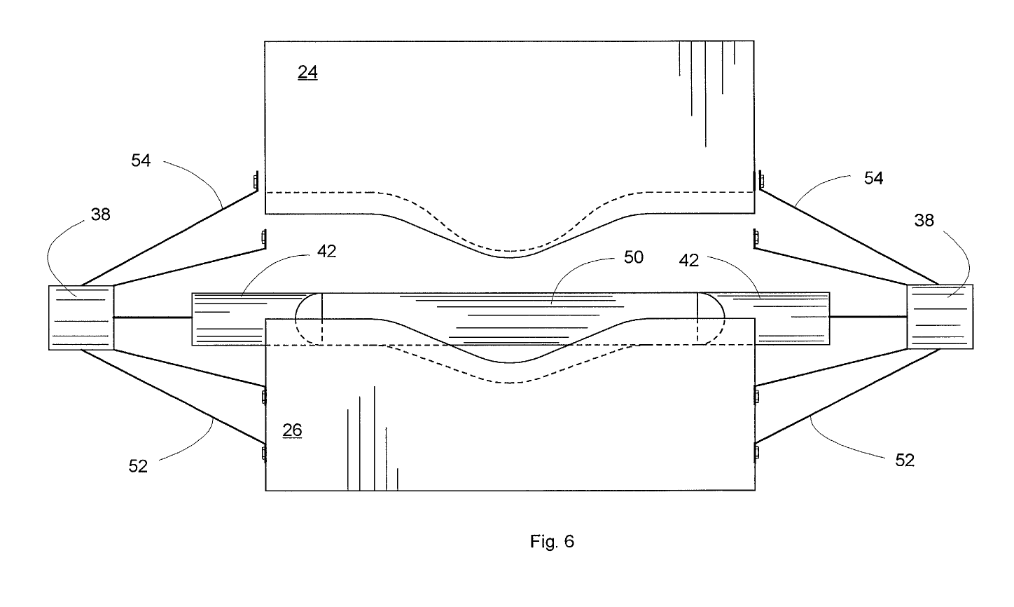

The first reason is to prevent bulging of the pipe 50 during its bending at the initial stage of hydroforming, as shown in FIG. 6. The second reason is to increase the inner pressure after closing the dies 24 and 26 to assure that all details of the work piece are properly formed and the smallest radii are filled sufficiently. The third reason is to avoid wrinkling of the duct walls. The fourth reason is to operate below the capacity of the hydraulic press.

For transition duct bodies with no offset 14 or a small offset, axial compression cylinders 42 need not be applied, so that the embodiment is as shown in FIG. 3. In such cases, any inward movement of the end caps 28a and 28b caused by bending of the pipe during the dies' closure will be reversed in the final stage of hydroforming. The final high hydroforming pressure will move the end caps outward to fill the dies' cavities. This will stretch the duct walls in the highest stress region causing some thinning of the walls in this region. Generally, a 10% thinning of the walls is acceptable.

In FIG. 5, the full diagram of hydraulic piping 46 to control the inner pressure and axial force in the compression cylinders is not shown because it is well-known in the art.

Recently developed internal pressure intensifiers 40 are capable of raising the maximum pressure to as much as 4,000 bar (58,000 psi). This presents an opportunity to produce novel circumferential ridges that will act as wall stiffeners. Such ridges could replace stiffening ribs that exist in the art that must be welded to the outside of the duct. The intensifiers need just a few minutes to reach 4,000 bar. The ridges could also serve as cooling ribs in the hottest region of the duct. Both high internal pressure and high axial force can be applied to produce the ridges. Intensifiers 40 are known to be energized by nitrogen gas, for example, from a pre-charged high-pressure tank. The working fluid pumped through the pipes 46 can also be water, oil, or some other fluid.

FIG. 6 shows a work piece pipe 50 placed in the lower die 26, being pressurized initially to a low inner pressure sufficient to prevent the pipe 50 from buckling of about 20.7 bar (300 psi), and ready for hydroforming. The axial compression cylinders 42 are snug against the end caps and the lower supports 52 of the cylinders are fastened to the lower die 26. This is to prevent the possible tilting of the pipe 50 ends during hydroforming.

Since pressure in a cylinder can be intensified to a maximum of about 10,300 bar (150,000 psi), the upper support 54 must be symmetrical or almost symmetrical to the lower supports 52. Otherwise, the large forces in the supports could cause an uneven displacement of the sides of the cylinder, thus tilting the cylinder. Prior to applying a high level of inner pressure, the dies 24 and 26 must close, and both the upper supports 54 and lower supports 52 must be tightly and uniformly fastened to their respective dies.

One alternative method to hydroforming a transition piece is to use gas forming. Small transition pieces can be produced by pressurization with hot gas. The gas method would be too dangerous for large ducts. The gas method requires a hot gas producer that would pressurize a work piece as well as heat the upper and lower dies.

An apparatus to make transition duct pieces according to the present invention will now be described. Depending on the complexity of the work required, two tooling arrangements will cover most of the transition duct bodies.

BASIC APPARATUS:

1. Main hydroforming press with upper die 24 and lower die 26 to accommodate a tandem work piece 50.

2. Small hydroforming press with a lower plunger die and an upper diaphragm die to produce semi-spherical end caps 28.

3. Water nozzle assembly 34 for the end caps 28.

4. Water pump, gauges, valves, and piping arrangement to pressurize the work piece.

5. Internal pressure controller.

6. Internal pressure intensifier.

7. Automatic welder for attaching the end caps 28.

8. Laser cutter to separate the ducts 10a and 10b and cut off the end caps 28a and 28b.

ADVANCED:

Same as the Basic Apparatus, plus the following:

9. Axial compression cylinders 42.

10. Cylinder pressure intensifiers for up to 10,300 bar (150,000 psi) 40.

11. Intensifier pressure controller and linear transducers 44, accurate up to 0.0125 mm (0.0005 inch) tolerance.

12. Large axial force can be used to increase the work piece wall thickness by compressing to compensate for thinning of the walls during the initial stage of hydroforming. In this case, a wall thickness transducer is required and an additional control loop in the controller is required.

Another embodiment of a method and apparatus according to the present invention includes making multilayered transition duct bodies. This is done by providing a plurality of concentric, cylindrical work pieces 50 nested within each other. They are fit together by chilling the inner cylinders and/or heating the outer cylinders with the required dimensional interference to assure structural integrity of the work piece pipe 50.

A two layer transition duct body provides better material utilization. The inner layer can be made of a relatively more costly heat-resistant material. The outer layer could be made of a relatively less costly material, thus lowering the total cost of the ducts.

A three layer transition duct would have the benefit of being able to dampen vibrations. Special anti-fretting and anti-vibration coatings can be applied on the surfaces between the concentric cylinders to increase both fretting resistance and damping. Experience indicates that a three layered transition duct can provide more damping than a two layered duct inside the turbine environment. The increased damping presents an opportunity to increase the life between removal for all ducts that have not been able to reach the desired minimum target life of 40,000 hours.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

I claim:

1. A method of making gas turbine transition duct bodies without longitudinal welds comprising the step of hydroforming at least one transition duct body from a tubular duct material.

2. The method of claim 1, wherein two substantially identical transition duct bodies are hydroformed simultaneously while joined in a back to back configuration.

3. The method of claim 1 further comprising the step of securing an end cap to each open end of the duct body before hydroforming such that the duct body is capable of containing internal pressure.

4. The method of claim 3, wherein said securing is welding.

5. The method of claim 3, further comprising the step of removably securing a pressurizing means to at least one of said end caps capable of pressurizing the inside of the duct body.

6. The method of claim 5, further comprising the step of providing an axial compression means adapted to apply compressive force to the end caps during hydroforming.

7. The method of claim 5 further comprising the step of providing an internal pressure intensifier to increase the pressure inside the transition duct body during hydroforming.

8. The method of claim 7 further comprising the step of pressurizing the inside of the transition duct body to an amount capable of forming circumferential ridges in the transition duct body.

9. A process for making at least one gas turbine transition duct body without longitudinal welds comprising the steps of
providing seamless, tubular duct material,
providing an upper die and a lower die suitably adapted to form at least one gas turbine transition duct body,
providing a pressurizing means to pressurize the inside of the duct body to an amount sufficient to prevent buckling while forming,
providing an axial compression means capable of applying compression to the ends of the duct,
securing end caps to the tubular duct material such that the inside of the duct material is capable of withstanding pressure,
pressurizing the inside of the duct body to an amount sufficient to prevent buckling during forming,
compressing the tubular duct material between the upper die and the lower die, and
compressing the ends of the duct material with the axial compression means.

10. The process of claim 9, further comprising the steps of
providing an internal pressure intensifier, and
forming circumferential stiffeners in the tubular duct material.

11. An apparatus for hydroforming transition duct bodies comprising
a main hydraulic press with an upper and lower die to accommodate a tandem work piece,
a small hydroforming press with a lower plunger die and an upper diaphragm die adapted to produce semi-spherical end caps,
at least one water nozzle assembly adapted to allow a working fluid into the interior of the work piece,
a water pump suitable for pressurizing the work piece,
an internal pressure controller, and
an internal pressure intensifier.

12. The apparatus according to claim 11, further comprising,
at least one axial compression cylinder,
a cylinder pressure intensifier with a nominal maximum output pressure of 150,000 psi,
an intensifier pressure controller, and
at least one linear transducer.

13. A two-layer transition duct body comprising an inside layer made of a heat resistant material and an outside layer made of a different material.

14. A three-layer transition duct body made from three concentric cylinders having anti-fretting coatings between the cylinder surfaces.

15. A three-layer transition duct body made from three concentric cylinders having anti-vibration coatings between the cylinder surfaces.

16. A method of making a multilayer transition duct body without longitudinal welds comprising the steps of
providing a plurality of pieces of tubular duct material of substantially the same diameter,
changing the temperature of at least one of the pieces sufficient to change its diameter by thermal expansion to a degree that permits a cooler piece to fit inside a warmer piece,
inserting the cooler piece inside the warmer piece to make multilayer tube material, and
hydroforming a multilayer transition duct body from the multilayer tube material.

17. The method of claim 16, further comprising the step of coating one of the mating surfaces of the tube material with an anti-fretting coating before inserting the cooler piece into the warmer piece.

18. The method of claim 16, further comprising the step of coating one of the mating surfaces of the tube material with an anti-vibration coating before inserting the cooler piece into the warmer piece.
